(19) United States
(12) Patent Application Publication
(10) Pub. No.: US 2012/0063684 A1
(43) Pub. Date: Mar. 15, 2012

(54) SYSTEMS AND METHODS FOR INTERACTIVE FORM FILLING

(75) Inventors: Laurent Denoue, Menlo Park, CA (US); John Adcock, San Francisco, CA (US); Scott Carter, Los Altos, CA (US); Patrick Chiu, Menlo Park, CA (US); Francine Chen, Menlo Park, CA (US)

(73) Assignee: FUJI XEROX CO., LTD., Tokyo (JP)

(21) Appl. No.: 12/878,972

(22) Filed: Sep. 9, 2010

(51) Int. Cl. G06K 9/34

(52) U.S. Cl. 382/175; 382/173; 382/176

(57) ABSTRACT

Systems and methods for interactive, user-driven detection, creation and completion of form fields in a digital document are provided. A document with form fields that require completion by a user is received, after which form fields are detected at the direction of the user. Once the user selects a possible form field, the system creates the appropriate fillable form field based on size, type, location, related text and other parameters of the form field and surrounding document. Additional levels of interaction include predictive text, pattern development and automatic completion of previously completed fields.

### BACKGROUND

1. Field of the Invention

This invention relates to systems and methods for filling in digital form documents, and more particularly to systems and methods for interactive, user-driven detection, creation and completion of fillable form fields in digital documents.

2. Description of the Related Art

Filling in digital form documents with fixed form fields that do not embed Form Definition Format (FDFs) typically requires users to print the documents, fill them out manually, and scan them back into digital form. Alternatively, users could import the document into image editing software, such as Adobe Acrobat® (Adobe Systems Incorporated, San Jose, Calif.) which uses the Portable Document Format (PDF), and carefully overlay text boxes, checkmarks and other characters or symbols over the appropriate locations on the document pages.

Even digital documents where all form fields can be edited pose problems. Users editing a document with form fields using word processing software must be careful to select the “insert” key when completing the form fields, or otherwise risk destroying the format and content of the form document. As a result, even filling in a form in an editable document can be difficult.

Finally, even form-fillable PDF documents, such as that illustrated in FIG. 1, can be inaccurate, as the entered characters 10 do not appear neatly in each designated character box 20. To enter one letter per box, the user must again carefully add spaces. Unfortunately, the FDF in this form authorized a maximum of 26 characters, so after too many spaces, the user can no longer enter characters for his/her first name.

Automatically detecting form-field locations and types is also error prone. Acrobat's® own “Automatic Form Recognition” feature still requires several steps to accurately create and fill in a form. Furthermore, the tool and user interface was designed for form publishers to add FDF into their existing documents, not as a way for end-users to create their own form fields and then complete a form.

### SUMMARY

Systems and methods described herein provide interactive, user-driven detection, creation and completion of fillable form fields in digital documents in a single, fluid process. A document with form fields that require completion by a user is received, after which form fields are detected at the direction of the user. Once the user selects a possible form field, the system creates the appropriate fillable form field based on size, type, location, related text and other parameters of the form field and surrounding document. Additional levels of interaction include predictive text, pattern development and automatic completion of previously completed fields.

In one aspect of the invention, a system for detecting and creating fillable form fields in a digital document comprises an input unit which receives input from a user on the location of at least one form field in a digital document; an identification unit which identifies the properties of the at least one form field; a classification unit which classifies the at least one form field in the digital document; and a generation unit which generates a fillable form field at the location of the at least one form field.

In a further aspect, the properties of the at least one form field include the location, size and shape.

In another aspect, the properties of the at least one form field are determined using a boundary search initiated from the location input by the user.

In a yet further aspect, the at least one form field may be classified as a text box, a multi-character text box, a check box or a radio button.

In still another aspect, the classification unit classifies the at least one form field based on text adjacent to the at least one form field.

In a further aspect, the classification unit further classifies the text box based on the content of text to be entered into the fillable form field.

In another aspect, the generation unit provides options for data to be entered into a text box based on the content of the text to be entered.

In still another aspect, the generation unit generates additional fillable form fields in additional locations in the digital document based on the identification and determination of a previous form field.

In a further aspect, the digital document is an image file.

In a further aspect, the fillable form field is created using HTML.

In a still further aspect, the system is a web-based application accessible using an Internet browser.

In another aspect, the user selects the digital document for detecting and completing of the form fields by inputting a uniform resource locator (URL) address corresponding to the location of the digital document.

In a further aspect, the identification unit identifies a first form field on a first page of a multi-page digital document and subsequently identifies identical form fields on additional pages of a multi-page digital document, and wherein the generation unit populates the identical form fields with the data entered by the user in the first form field on the first page.

In a yet further aspect, the identical form fields are highlighted.

In a still further aspect, the information on the fillable form fields generated for a particular digital document are stored for future use with similar digital documents.

In another aspect of the invention, a method for detecting and creating fillable form fields in a digital document comprises receiving an input from a user on the location of at least one form field in a digital document; identifying the properties of the at least one form field; classifying the at least one form field in the digital document; and generating a fillable form field at the location of the at least one form field.

In a further aspect, the method further comprises inputting data into the at least one fillable form field.

In another aspect, the properties of the at least one form field include the location, size and shape.

In a yet further aspect, the at least one form field is classified as a text box, a multi-character text box, a check box or a radio button.

In still further aspect, the at least one form field is classified based on text adjacent to the at least one form field.

In yet another aspect of the invention, a computer program product for detecting and creating fillable form fields in a digital document is embodied on a computer readable medium and when executed by a computer, performs the method comprising receiving an input from a user on the location of at least one form field in a digital document; identifying the location of the at least one form field; determining the characteristics of the at least one form field in the digital document; and generating a fillable form field at the location of the at least one form field.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. Specifically:

FIG. 1 illustrates a related art image of a fillable form field;

FIG. 2 illustrates a block diagram of a system for creating and completing fillable form fields in a digital document, according to one embodiment of the invention;

FIG. 3 illustrates a method of creating and completing fillable form fields in the digital document, according to one embodiment of the invention;

FIG. 4 illustrates a related art image of a digital document with form fields, according to one embodiment of the invention;

FIG. 5 is an illustration of form fields with color or shading, according to one embodiment of the invention;

FIG. 6 is an illustration of form fields which require applying a pre-defined shape around a value, according to one embodiment of the invention;

FIG. 7 is an illustration of form fields with related text that is used to determine the appropriate characteristics of the form field, according to one embodiment of the invention;

FIG. 8 is an illustration of related form field types, which the system can identify automatically, according to one embodiment of the invention;

FIG. 9 is an illustration of form fields where specific symbols can be identified to determine the form field type, according to one embodiment of the invention;

FIG. 10 is an illustration of form fields with multiple single-box fields which are detected by user selection of any single box, according to one embodiment of the invention;

FIG. 11 is an illustration of form fields where text adjoining the form field determines the form field type and permits the use of an auto-completion feature, according to one embodiment of the invention;

FIG. 12 is an illustration of multiple line form fields which can be identified by the inventive system, according to one embodiment of the invention;

FIG. 13 is an illustration of text box form fields without complete borders which can be detected by the inventive system, according to one embodiment of the invention;

FIG. 14 is an illustration of form fields determined to be radio buttons, according to one embodiment of the invention;

FIG. 15 is an illustration of radio button form fields which are determined to be mutually exclusive based on surrounding text, according to one embodiment of the invention;

FIG. 16 is an illustration of form fields which can be limited to certain types of characters and symbols based on surrounding text and symbols, according to one embodiment of the invention;

FIG. 17 is an illustration of form fields within a table which are justified in accordance with the justification of the surrounding table headers, according to one embodiment of the invention;

FIG. 18 is an illustration of form fields with data field patterns which are recognized by the inventive system, according to one embodiment of the invention;

FIG. 19 is an illustration of form fields where related text provides for the inclusion of a date-picking control widget, according to one embodiment of the invention;

FIG. 20 is an illustration of form fields with common field names which are detected in order to provide drop-down menus for completion of the fillable fields, according to one embodiment of the invention;

FIG. 21 is an illustration of form fields where related text present within the form field is used to determine the form field type, according to one embodiment of the invention;

FIG. 22 is an illustration of a system for identifying the boundaries of a form field, according to one embodiment of the invention;

FIG. 23 is an illustration of a system for determining the presence of a lip on a baseline, according to one embodiment of the invention;

FIG. 24 is an illustration of a system and method for identifying adjacent character boxes in a multi-box field, according to one embodiment of the invention;

FIG. 25 is a block diagram of a computer system upon which the system may be implemented.

### DETAILED DESCRIPTION

In the following detailed description, reference will be made to the accompanying drawings. The aforementioned accompanying drawings show by way of illustration, and not by way of limitation, specific embodiments and implementations consistent with principles of the present invention.

The systems and methods disclosed herein provide, in one embodiment, an application for viewing a digital document, where each page of a digital document is shown as an image, over which users can seamlessly type in text, check checkmarks, select radio-buttons, and enter other characters and symbols into form fields even though the form field is not predefined in the document image. The application may be web-based, wherein a user can simply upload a digital document to a server on a network which runs the form-filling application. The user may also operate the application within an Internet browser application and simply enter a website address of a web-based document, which will then be scanned into the system for identifying and creating fillable form fields.

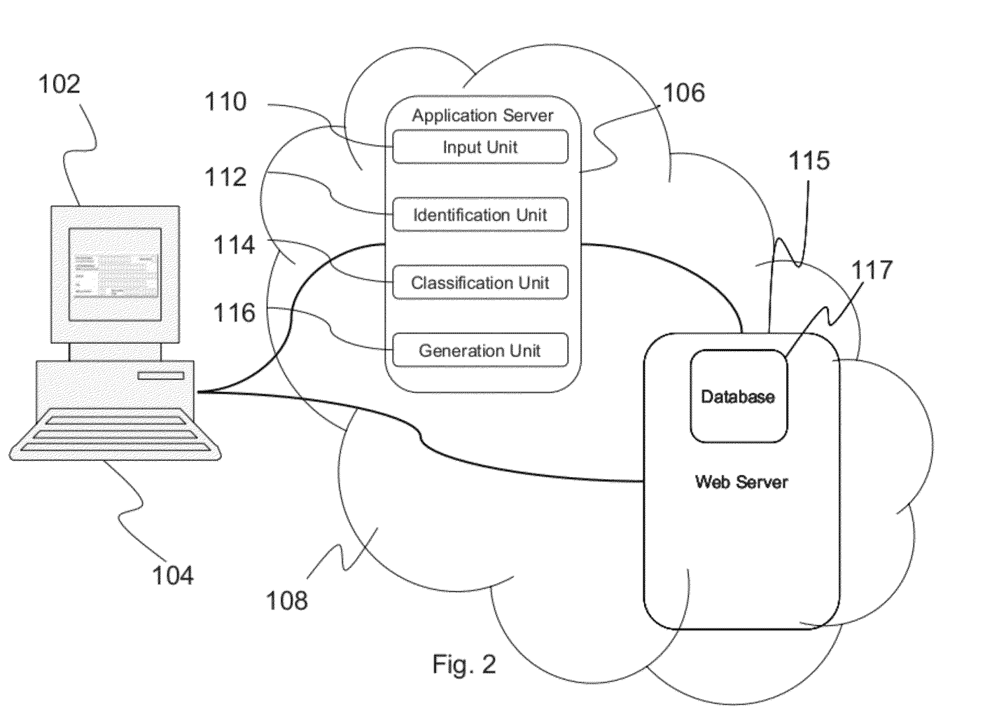

In one embodiment, as illustrated in FIG. 2, the system 100 includes a computer 102 with a display and input device 104 used by the user to interact with the application, which can be a combination of software and hardware being run, for example, on an application server 106 connected with the user's computer 102 through a network 108 such as the Internet. The application server 106 running the embodied system may include an input unit 110, an identification unit 112, a classification unit 114 and a generation unit 116. The input unit 110 receives input from the user on the location of at least one form field in a digital document. The identification unit 112 identifies the properties of the form field, including the location, size and shape, as will be described in greater detail herein. The classification 114 unit classifies the form field, such as the type of character or symbol that should be entered into the form field. Finally, the generation unit 116 generates a fillable form field at the location of the form field so that the user can input data into the form. In one embodiment, the digital document may be stored on a database 115 inside a web server 117, which may be connected to the computer 102 and server 106 over the network 108. A user accessing the digital document on the web server 117 may request that the application server 106 obtain the digital document from the database 115 to process for generating fillable form fields. The user is then able to create a fillable form document from any available digital document on the network 108.

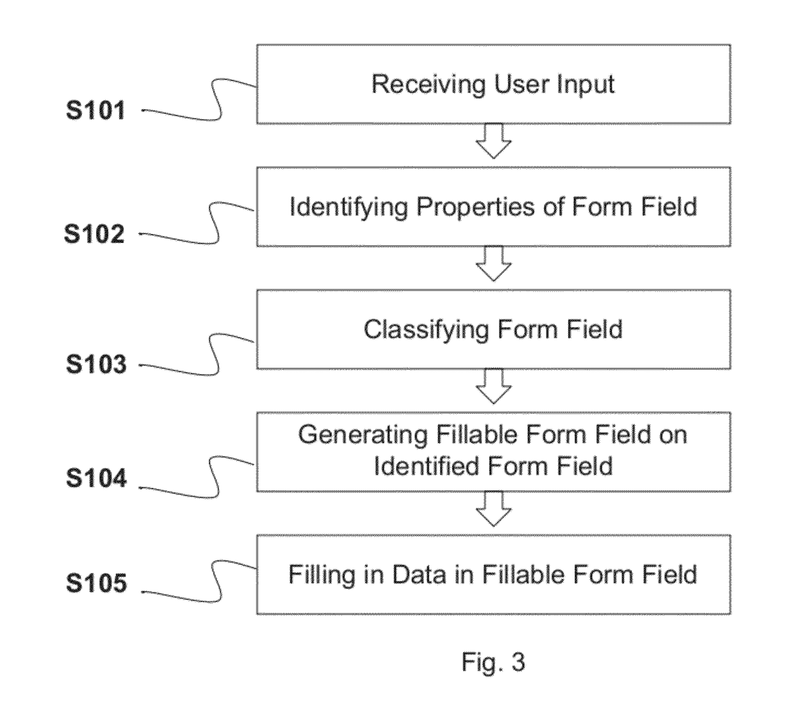

FIG. 3 illustrates a method of creating and completing form fields in a digital document. In a first step (S101), the user input on the location of at least one form field is received. Next, the properties of the form field, such as its location, size and shape, are identified (S102). The form field is then classified based on the type of symbol or character that should be entered (S103). Next, a fillable form field is generated at the location of the form field (S104), wherein the user may then fill in the field with appropriate data (S105).

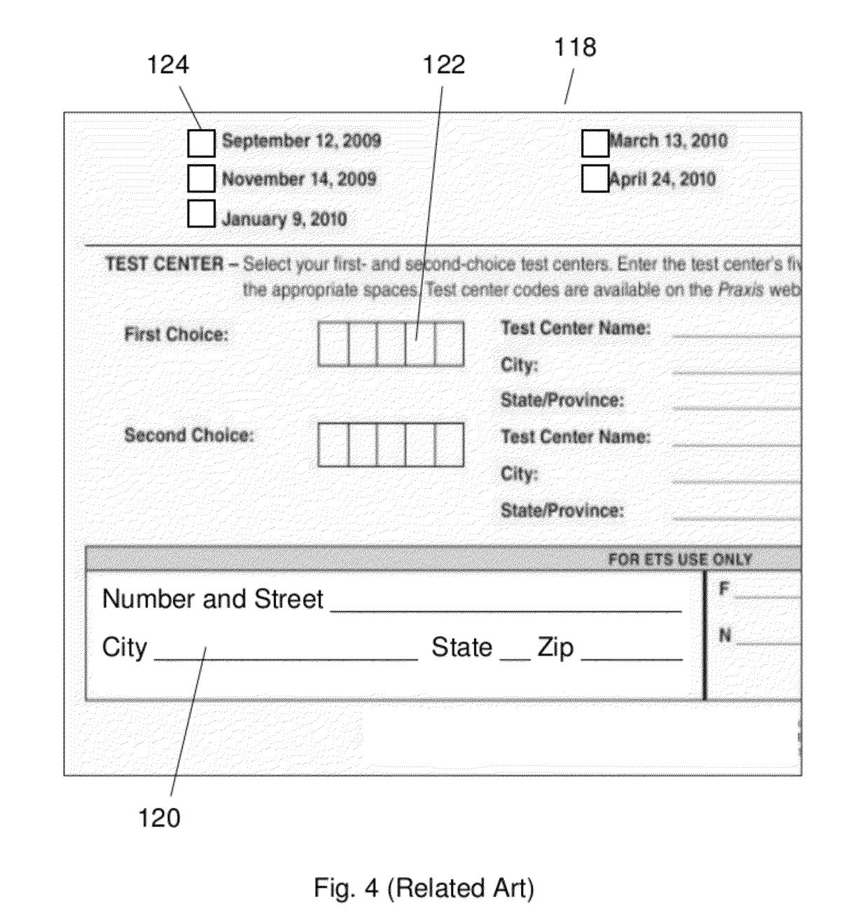

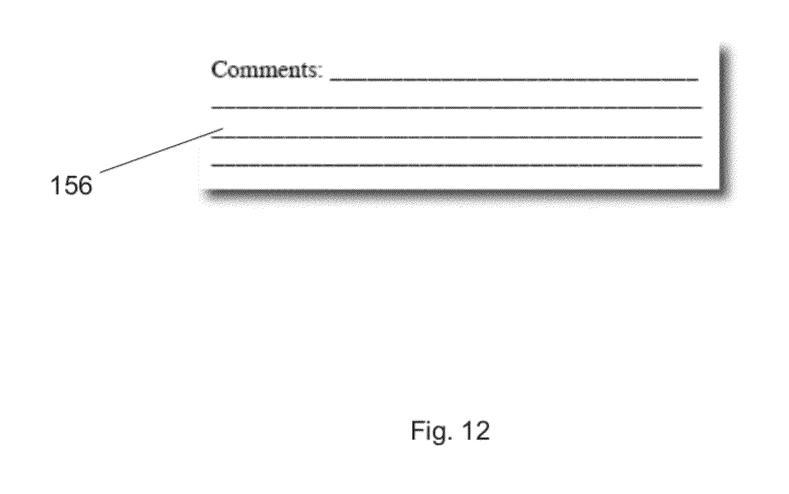

An example of a digital document with form fields is shown in FIG. 4. The system involves the user by asking the user to select a location on the document 118 where they see the need to enter some kind of information in the form. It could be a text box 120, the first line of a multi-line field (see FIG. 12), or a form field of multiple single-character entry boxes 122. In one embodiment, the user uses a mouse to select the appropriate location on the digital document, allowing for easy maneuvering around the page and between each form field.

The system also applies previous user interactions to detect other form-fields. For example, when a checkbox 124 is identified, the pattern is searched in the rest of the document; users can simply hit “TAB” to move to the next form fields for improved efficiency.

The system also allows seamless editing, where users can select the first single-character box 122 of a multiple single-character form field and keep typing. The characters will appear in the next box automatically. If the user clicks on a box that was already filled, the cursor appears at that position, allowing users to add, backspace or delete characters as in a normal text field. Text alignment in table cells is also automatically set based on the layout of header cells.

The system is also able to recognize multiple single-boxes and groups of radio buttons based on proximity, and also textual content nearby, even if they look like checkboxes (e.g. [ ] Yes [ ] No).

In another embodiment, the system suggests useful form-completions for fields, for example date/time pickers and place/state/country drop-down menus. The system can also restrict the type of content (e.g. alpha or numeric) to be input (e.g. only digits if followed by % or preceded by $).

The system also stores previous interactions on a given document to benefit others who might need to fill similar documents. For example, information on the fillable form fields generated on one particular document are stored for future use in a similar document. By storing interactions, the system becomes better at automatically detecting form fields.

In one embodiment, the system converts any document or web page into an image file, and then uses HTML to create the form fillable fields in the appropriate sections, as will be further discussed below.

### I. User Interface

An input document (PDF, Word, PowerPoint, image file) is rendered into page images using available tools such as Ghostscript (www.ghostscript.com) or XPDF (www.foolabs.com/xpdf) (converting, for example, PDF to JPEG or PDF to PNG). A PowerPoint slide could be exported as an image as well, using OpenOffice™ (www.openoffice.org) or the Microsoft® Office Suite (Microsoft Corporation, Redmond, Wash.). Images are shown to the user. When the user clicks a point (x, y) on the image, the system determines the corresponding form-field type and its extent. The user can immediately start typing text in a text-based fillable form field, or the system automatically adds the appropriate mark (e.g. radio button selected or unselected, checkbox checked or unchecked, option circled or not circled).

### II. Determining Form Fields

From a page image and a user-selected location, the system determines the properties of the form field, such as the location, extent, and type, for example 1) a closed box 2) a box opened on the top, or 3) a line underneath, 4) a circle.

A difficulty with general form recognition is coverage of the many different types of forms. However, all that is needed here is to perform recognition of limited types of objects. The system relies on several image processing steps, including optical character recognition (OCR), line and line-crossing finding, and colored region finding. For OCR, there are a number of commercial systems, e.g., ABBYY (www.abbyy.com), Microsoft® Office Document Imaging (http://office.microsoft.com/en-us/help/about-microsoft-office-document-imaging-HP001077103.aspx), and OCRopus™ (code.google.com/p/ocropus/). Line finding can be performed using edge detection followed by a Hough transform, as described in R. Duda and P. Hart, “Use of the Hough transformation to detect lines and curves in pictures,” Comm. ACM, Vol. 15, No. 1, pp. 11-15 (1972). A simpler approach that can be used since forms generally contain horizontal and/or vertical lines, and not other orientations (assuming there is minimal skew), is to follow the “black” pixels horizontally or vertically across a page, allowing for slight “jogs.” In colored region finding, by limiting colored region finding to regions with the same pixel values (or average pixel values in a small window), the system can identify the extent of colored regions. In one embodiment, a preprocessing step can also include skew detection; any of the deskewing algorithms (e.g., that disclosed in Yang Cao, Shuhua Wangb and Heng Li, “Skew detection and correction in document images based on straight-line fitting,” Pattern Recognition Letters, Vol. 24, No. 12, pp. 1871-1879 (2003)) can be used to deskew a scanned page prior to use of the system.

In one embodiment, if the system is not correctly identifying the desired region, the user can invoke a fall-back, or default mode where a rectangular region is swept using the mouse. The region is shown in the viewer and the user can type inside the identified rectangular region. The corners of the region can also be adjusted similarly to those found in traditional graphical tools.

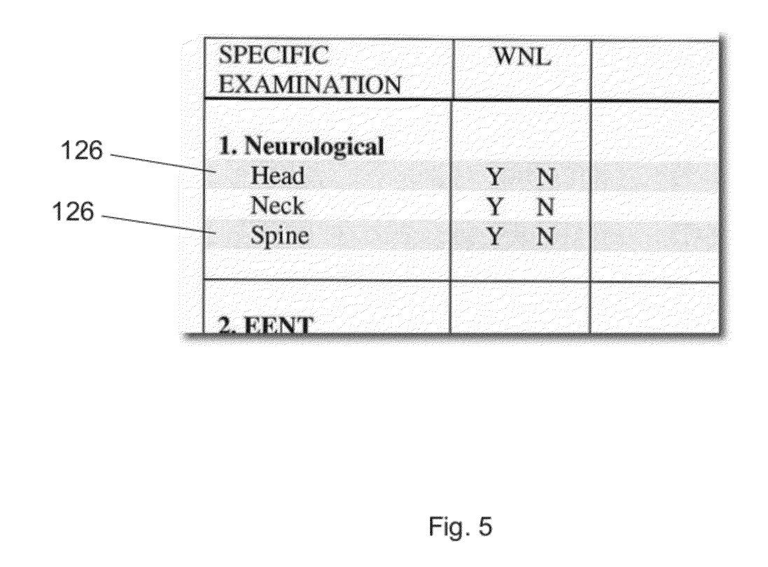

Some forms may be colored or have shading to distinguish form fields. For example, the lines or columns defining the boxes may be colored or shaded, as illustrated by the shaded lines 126 in FIG. 5. Colored forms are handled by detecting the predominant color around the immediate region selected by the user. Checking the extent of the color in the horizontal and vertical directions can be used simultaneously with identifying the nearest horizontal and vertical lines to determine the boundaries of the form field. However, some forms may have colored backgrounds that are not indicative of input extent. These cases can be handled either by invoking the default mode (i.e., specifying a rectangular region to type in), or setting an option within the system to ignore color.

### Checkboxes

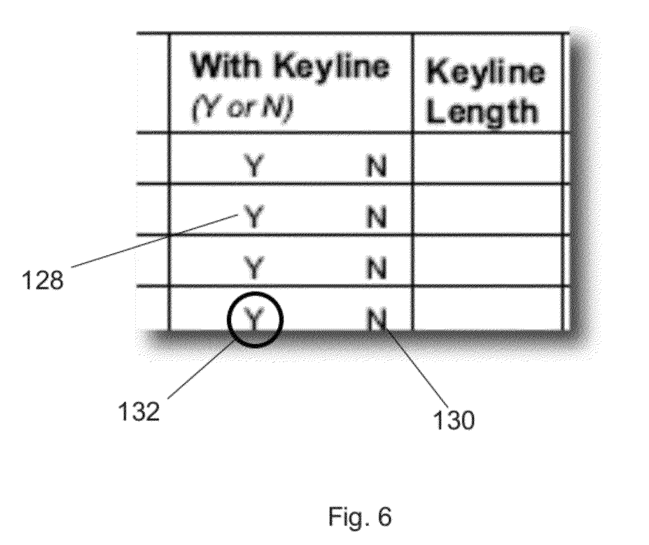

In the embodiment illustrated in FIG. 6, when the user clicks on a common single-choice value such as “Y” 128 for Yes or “N” 130 for No, the system detects that the user has selected a point within a text box and applies a predefined shape around the value; here, a circle 132 to mark-down the option. The text within the text box may be detected through OCR or a tool such as XPDF.

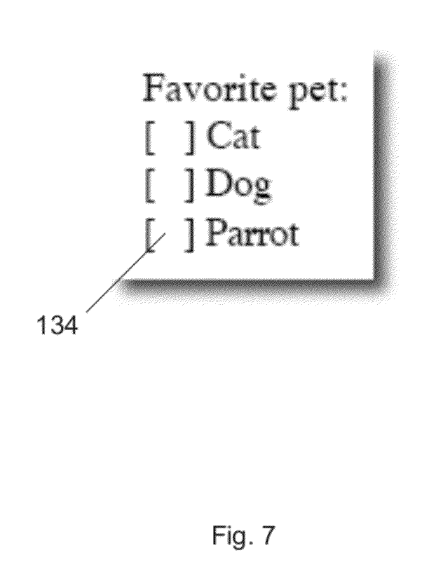

In FIG. 7, when the user clicks inside the brackets 134, the system also uses text in the document to determine field-type. Here, the common pattern of brackets (a vertical edge and two lips extending to the right or left) is interpreted by the classification unit as indicating a checkmark fillable form field, and the generating unit then generates a checkbox fillable form field.

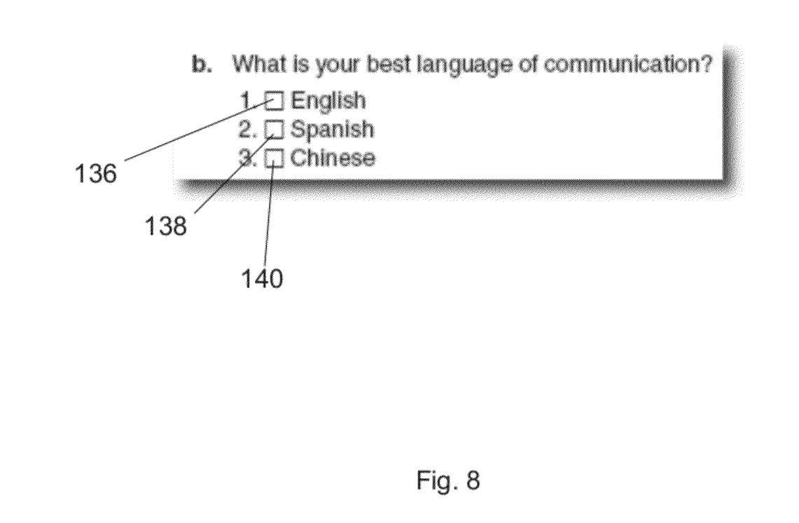

In FIG. 8, once a checkbox 136 has been found, the system automatically detects the location of other checkboxes with similar appearance 138, 140 on the page, generates additional checkbox fillable form fields, and allows users to tab through the fillable form fields.

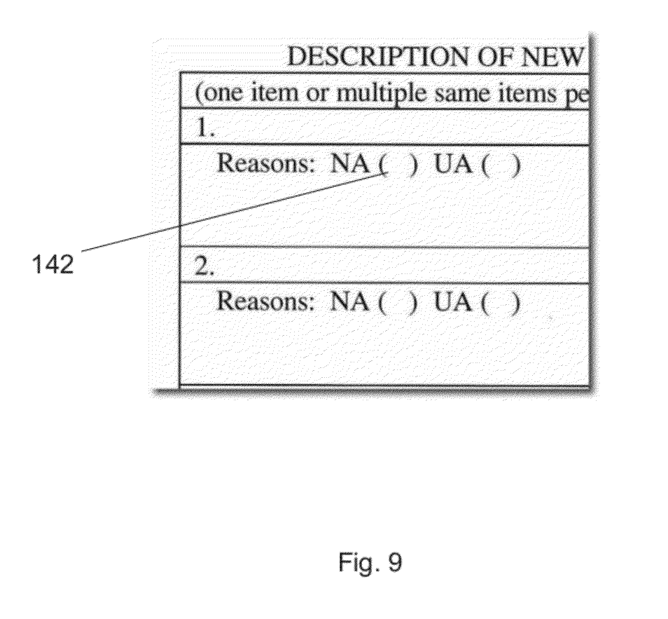

FIG. 9 illustrates an embodiment where parentheses 142 are often used in a form field to indicate checkmarks or radio groups. The identification unit, using the boundary detection disclosed below, will determine the presence of the parentheses, after which the classification unit will then classify the form field as a checkbox. The generation unit then generates the appropriate checkbox-type fillable form field between the parentheses 142.

### Multiple Single-Character Fields

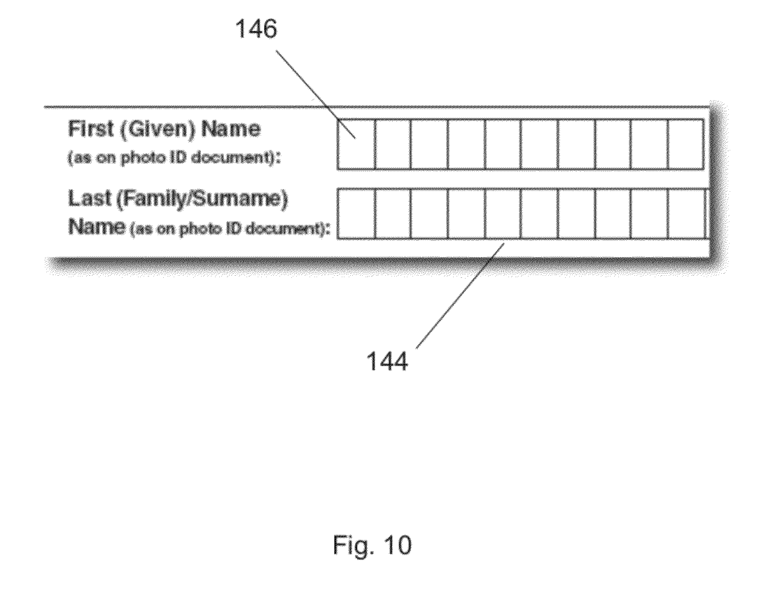

In a form field with multiple single-character fields 144, as illustrated in FIG. 10, the system tries to find a recurring pattern on the left and right of the location selected by the user. In one embodiment, the cursor (not shown) for entering text is placed inside the left-most box 146, and the user starts typing. Each keystroke fills the corresponding box with the character and moves the cursor to the adjacent box, backspace clears the current character and moves back one box, and arrow-keys move back and forth between the boxes. If the user had already entered text inside the box and again selects that location, editing starts in that box instead of going to the first leftmost box.

In one embodiment, multiple single-box fields may be detected after the user clicks on any box. However, if nothing has been entered in any of the boxes, the cursor is automatically positioned at the first box 146.

### Text Fields and Multiple Lines

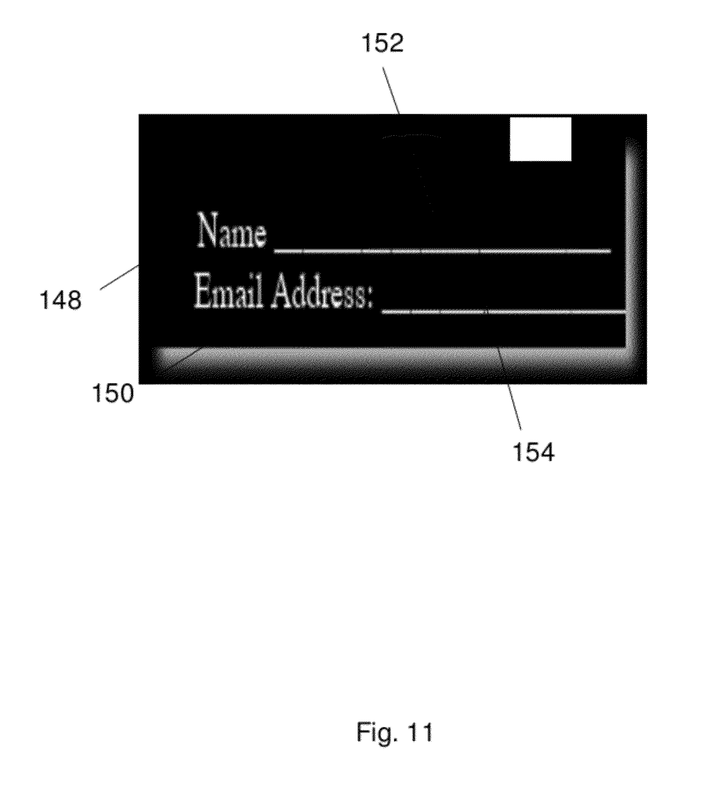

In one embodiment, the system tries to find more fillable form fields below and above the currently detected line. If text is found on the left of the next line below the current line, the system considers the next line as a different form field, presumably because the text represents a different form category, as illustrated with the “Name” 148 and “Email Address” 150 text in FIG. 11. Otherwise, editing starts at the first selected line, and when characters flow over a pre-determined limit, the cursor is automatically positioned onto the beginning of the next line. The limit may be determined using the size of text adjacent to the form or using the measured boundaries of the lines in the text fields. Full editing is supported, so if text was already entered, characters and lines flow correctly.

Common field names such as “Name” 148 or “Email Address” 150 can benefit from the auto-completion features already stored by an Internet browser's auto-complete list. In FIG. 11, overlayed HTML fillable form fields 152, 154 are named “name” and “email,” respectively, so that as users type, the text field will auto-complete name and email address values they previously entered or stored in the browser.

FIG. 12 illustrates multi-line input fields 156. The system automatically detects multi-line input fields 156, and treats text editing as would normally happen in a text editor or word processor. This may also include automatically changing the font size to fit the entered text within the lines provided in the text field. For example, as the user types text into the lines of the “Comments” fillable form field 156 and reaches the end of the last line, the font size of all of the entered text on all of the lines may begin to shrink to allow the user to include additional text in the limited amount of space.

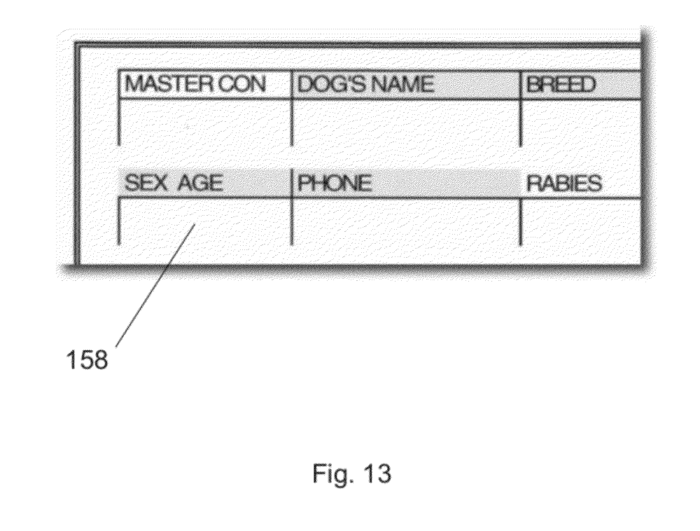

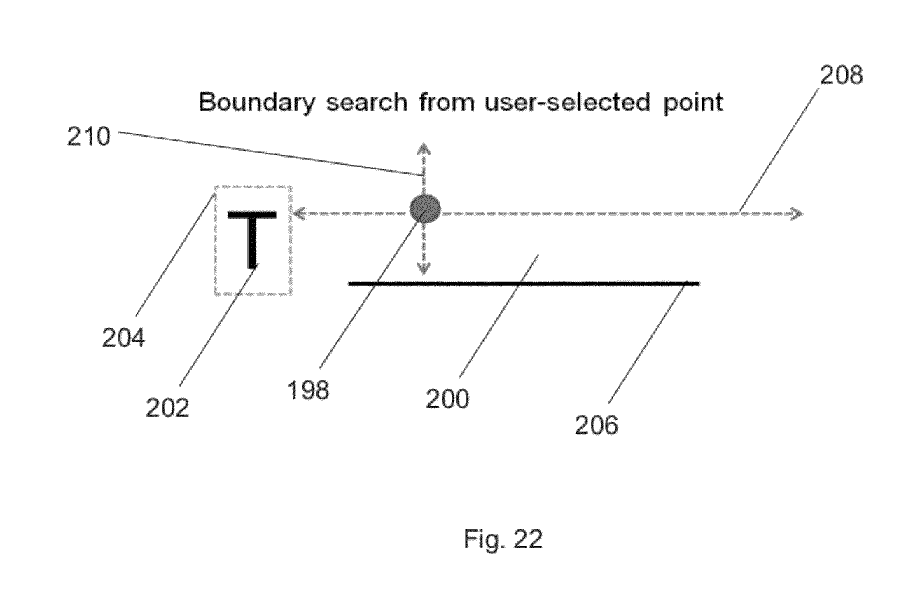

The system can detect text fields even when the box 158 is open on the bottom, as illustrated in FIG. 13. In order to detect this type of text field, the system uses a maximum height heuristic to determine the maximum possible height of text in the field. The properties of the text field used to determine the maximum height are similar to those described below when determining the maximum height of text in a field with only a bottom line (see FIG. 22 and the discussion of Identifying a Form Field, below).

### Radio Groups

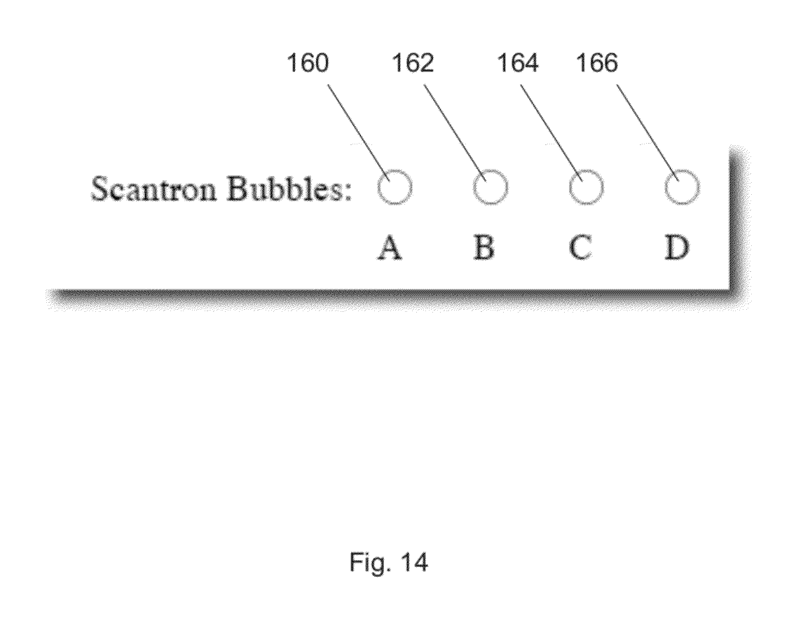

When detecting a form field known as a “radio button” 160, as shown in FIG. 14, the system tries to find similarly shaped radio buttons to the side, or directly below and above the current radio button 160. Since it is difficult to automatically determine if radio buttons belong to a group, the user can further designate an area around several radio buttons (by drawing a rectangle shape) that he/she wishes be treated as a group.

In FIG. 14, when a circle is selected by the user, the identification unit determines that the shape looks like a circle and treats it as a radio button. Nearby fields 162, 164, 166 are automatically detected as such. If the radio buttons are identified in a group, if the user clicks another circle, the previous selection is cleared.

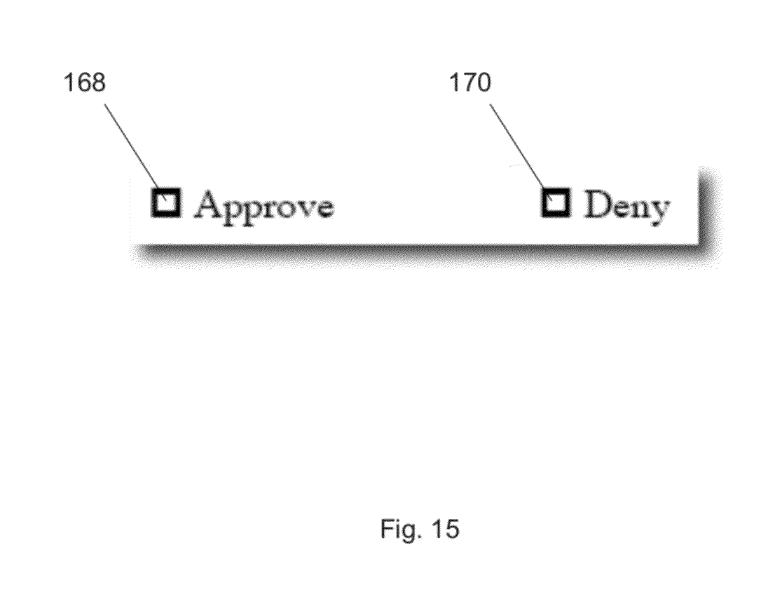

FIG. 15 illustrates one embodiment where the system can use synonyms/antonyms to determine that a set of checkboxes 168, 170 are mutually exclusive (and thus should behave like radio buttons), based on nearby text, such as “approve” and “deny.” In this case, if one box is “checked” by the user, the other box can only be checked if the first box is “unchecked,” and vice-versa.

### Text Editing and Formatting

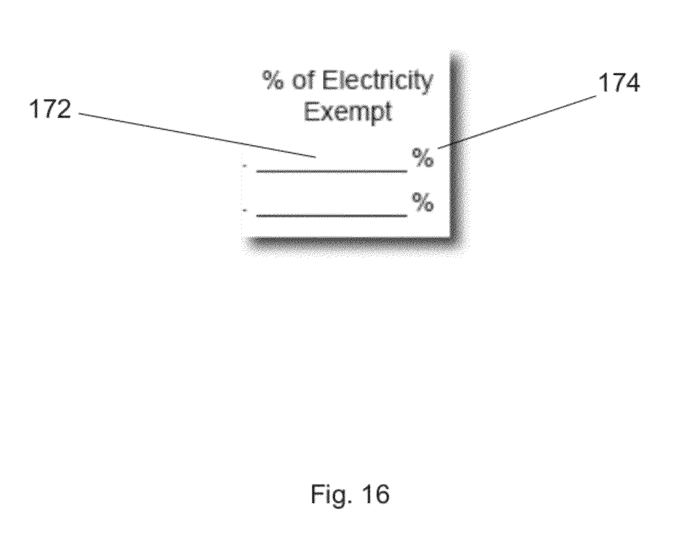

In one embodiment, the system can automatically restrict the type of characters that can be input into a fillable form field based on text found before or after the field. As illustrated in FIG. 16, when a text field 172 is followed by common units such as “%” 174 or “$” (not shown), the system can automatically prevent users from entering non-digits and restrict the field 172 to numerical characters. For example, the system can check that the zip code, email address, and phone number in FIG. 4 are valid formats.

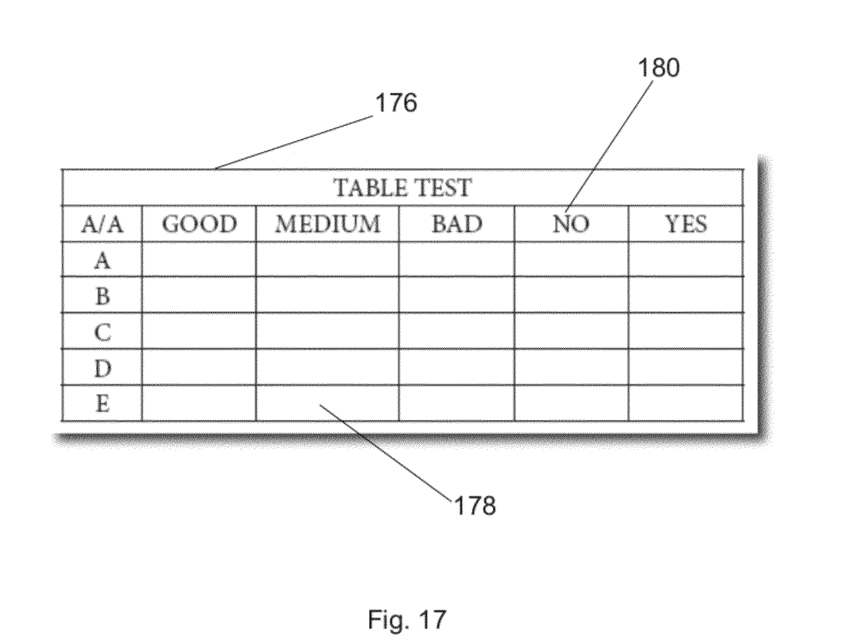

Also, text justification in a table cell is automatically set to the same justification present in the header (left/center/right). In tables 176, as shown in FIG. 17, when a user clicks a cell 178, the system automatically follows the left/center/right justification of table headers 180 found on top. Here, text would automatically be centered.

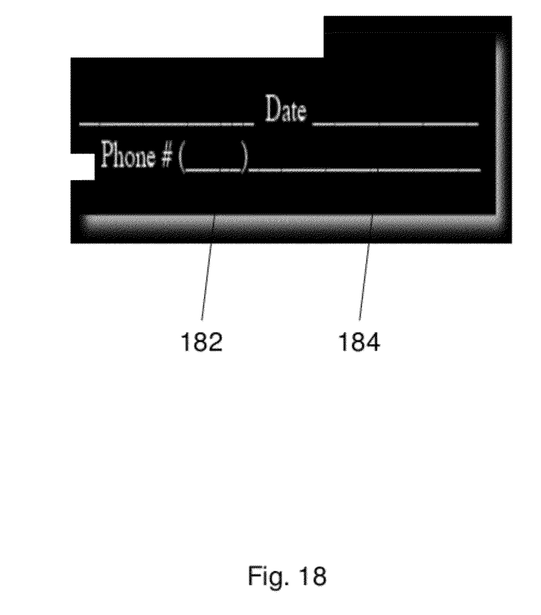

In another embodiment, common field formats and data patterns are recognized, as shown in FIG. 18. In one example, a phone number is often written (650) 555-5554. Users can enter 3 digits between the parentheses 182, and the system automatically detects that digits were entered, determines if an adjacent text field is present, and moves the location of any following text to the space 184 after the closing parentheses.

In a further embodiment, the system is also able to recognize identical form fields across multiple pages of a multi-page document. The system may highlight the identical fields with a specific color or shading pattern, or the system may fill in data from the first completed field in the subsequent identical fields so that the user does not have to enter the same data on multiple pages. This situation may occur with data such as dates or Social Security Numbers which often appear on multiple pages of a document. If the system enters the data in subsequent identical fields for the user, the system may still alert the user to the pre-populated data through a message or by highlighting the identical fields with specific colors or shading patterns.

### Form Completion Through Auto-Complete, Drop-Down Menus and Widgets

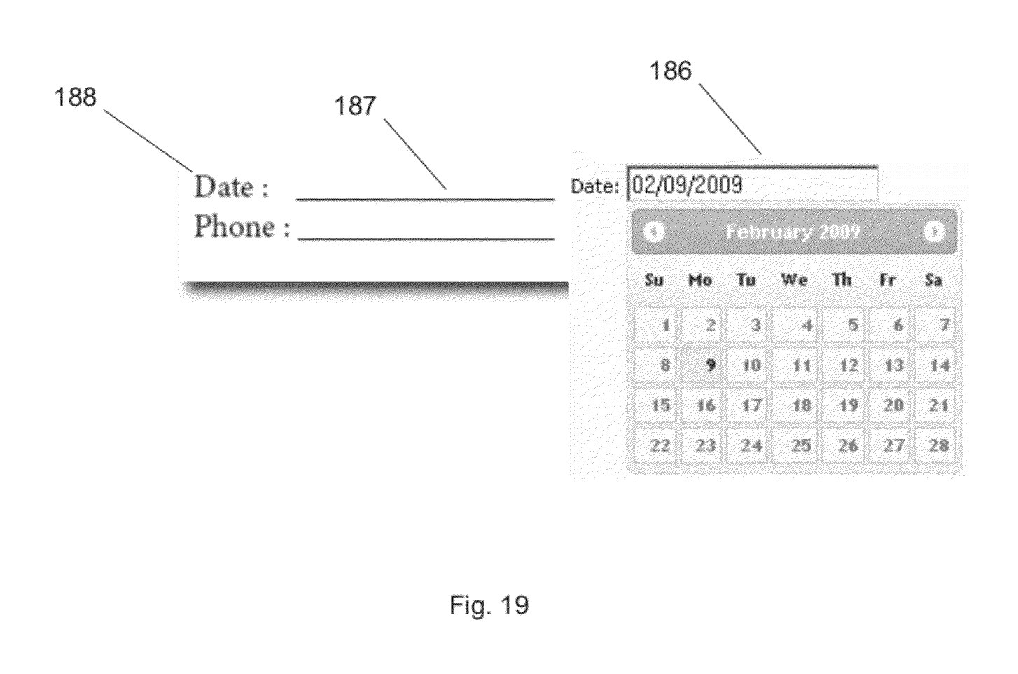

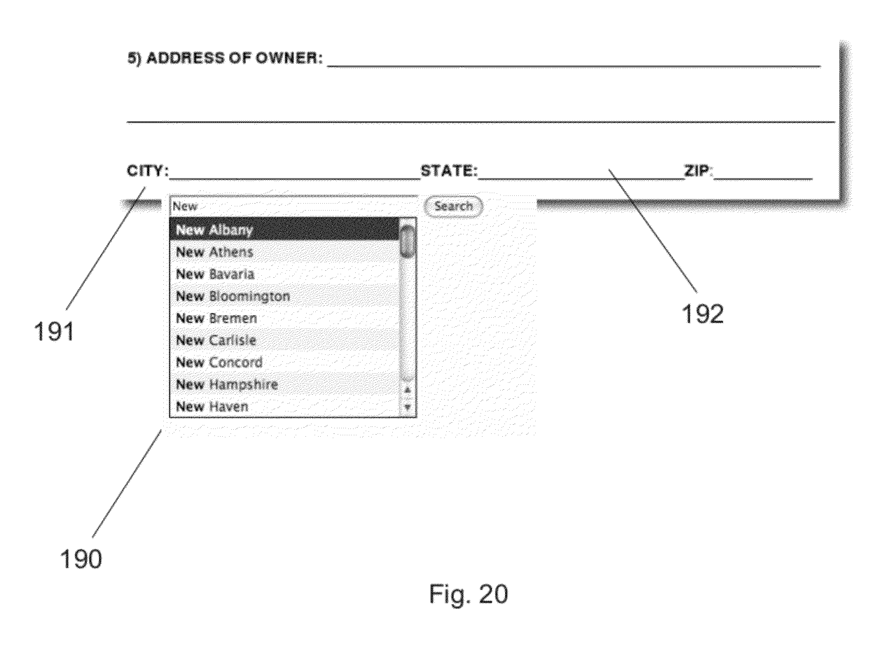

In another embodiment, the system uses auto-complete features such as drop-down menus and widgets in order to suggest entries in the fillable form fields to the user. In FIG. 19, the system may overlay a date-picker 186 based on textual content. The system overlays a date-picker control 186 on or near a text field 187 that looks like a date, here based on the text “Date” 188 found to the left of the detected text field 187. In FIG. 20, the system presents a drop-down menu 190 for a city field 191, and would similarly present a drop-down menu (not shown) for the state field 192.

Date pickers can also be added over multiple single-box fields if, for example, 6 or 8 boxes are detected and/or the nearby text reads “date.” The 6 or 8 boxes would then be determined to correspond to a date field in the month/day/year format—MM/DD/YY or MM/DD/YYYY. Similar treatment happens for other types such as 2 box fields near “state” text.

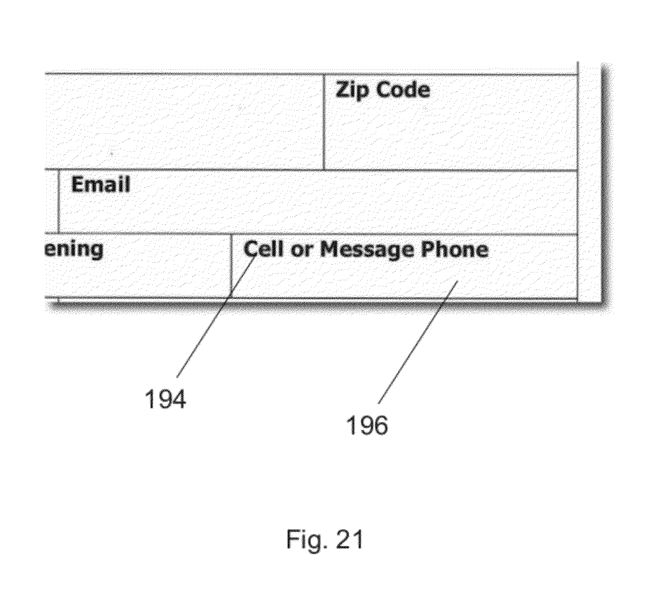

Text fields 194 may occur inside a box 196, as illustrated in FIG. 21, and appropriate completion aids can be invoked. In one embodiment, these can be distinguished by looking for phrases from a small vocabulary of commonly-used text fields stored in a system database.

### Identifying a Form Field

In one embodiment, to identify and classify the extent of the form field, the system searches for the boundaries of the form field starting with a user-selected point 198, as illustrated in FIG. 22. The searching starts from the user selected point 198 selected by the user in a form field 200 identified by the user. Upon detection, text 202 to the left of the user-selected point is surrounded by a bounding box 204 shown on the left. The bounding box 204 is created to provide adequate spacing between the existing text (in this case, the “T”) and newly-entered text, so that there is no overlap of text. Without the bounding box, the horizontal detection from the user-selected point may pass under the top horizontal line of the “T” and impact the vertical line of the “T.” The system may then decide that the next text character may be entered much closer to the “T” than would otherwise appear normal. The baseline 206 of the form field is shown on bottom. The horizontal path 208 and vertical path 210 of the search that is being performed from initial selection point 198 is shown by the dotted lines and directional arrows.

In one embodiment, the method of identifying a form field, or element, starts from a raster image of the form page in question, and the position and content of the text of the page. The first step of identifying the extent of the form element and classifying can be performed as follows:

1) The user selects a point within the desired form field.

2) If the user selection is within a text box where text already exists, the system interprets the form field to be an “option selection” form field. The pre-existing text is selected or circled and processing stops. In cases where the same text is re-selected, the selection/circling would toggle between a selected and unselected state.

3) Using the region grow methodology, the color of the document background at the user-selected point is used as the seed from which to grow the region which is to become the fillable form field. Alternatively, the background color of the document (or region) may be already determined, in which case the closest background point is used. This would free the user from position errors on forms with small checkboxes.

4) From the user-selected point, the boundaries of the field are found by searching in each direction for an edge or boundary, such as using the region grow methodology to find a color significantly different than the initial point. FIG. 22 illustrates the searching which occurs in each direction, and illustrates how the searching can identify the left boundary of the form field when it encounters the existing text, “T” 202. The lower boundary of the form field can be identified by the baseline 206. In one embodiment, text boxes or optical character recognition (OCR) results are used in addition to the rendered page to bound the search. The boundary search would stop at a text box.

5) The search is performed subject to a maximum reasonable extent, wherein the maximum reasonable extent is determined based on the size of the page and/or size of the text on the page. For example, the extent of the vertical search in FIG. 22 is limited to a small constant times the expected text size. The expected text size may be determined based on the size of the text surrounding the field, such as the “T” 202 in FIG. 20.

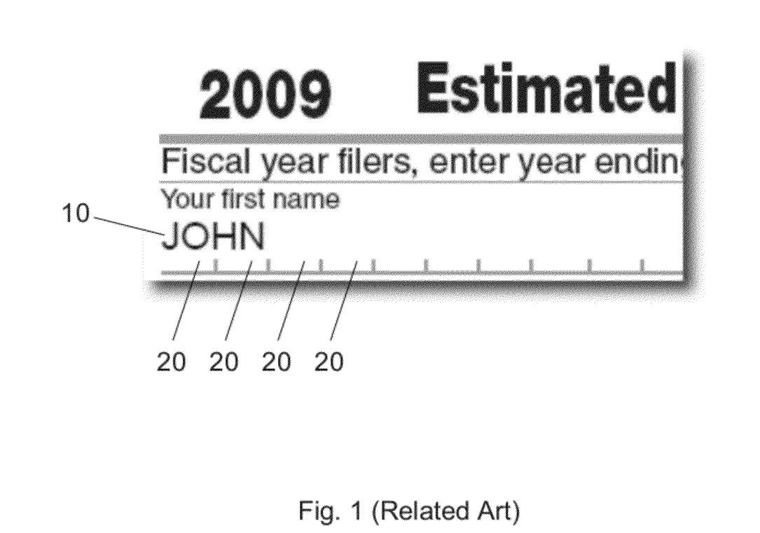

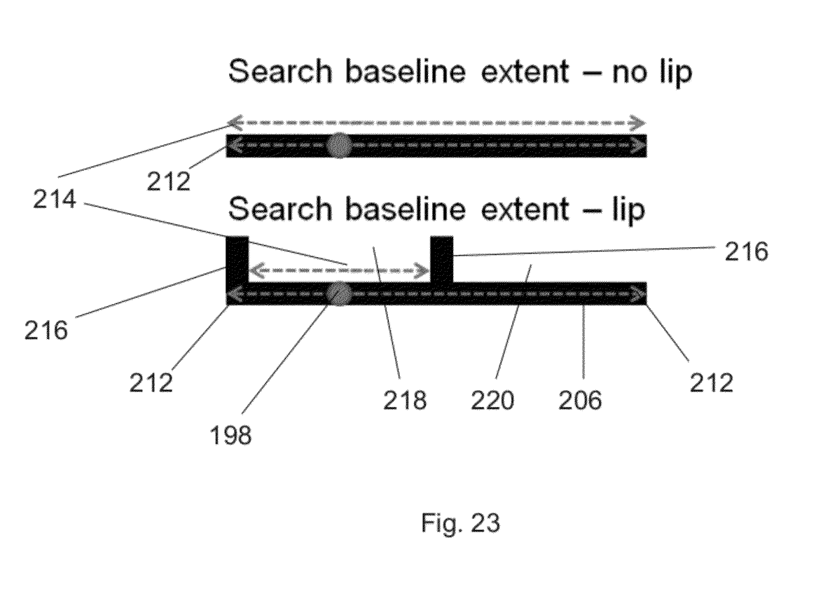

6) In form fields which are text boxes, the baseline 206 of the form must also be analyzed to determine the internal and external boundaries of the form field, as illustrated in FIG. 23. In these baseline heuristics, once initial boundaries are identified, the baseline (if present) is used to limit the horizontal extent and partially classify the field. From the detected point 198 of the baseline, a search 212 is performed along the baseline 206 to the left and right to determine the extent of the baseline, as shown in FIG. 23. Simultaneously, a search 214 is performed just above the detected baseline for a lip 216, which would indicate a form field which includes sub-fields 218, 220 for single characters, as shown in FIG. 1. If the baseline 206 ends within the previously found horizontal borders, the extent of the baseline is used to replace the horizontal borders. If the baseline is found to have a lip 216, the extent of the field is stopped at the lip, and the horizontal extent of the field is limited to this value. The field is then limited to entry of a single character if similar adjacent fields are detected. As discussed above, the system will determine if similar fields exist nearby, and the remaining adjacent fields beyond each lip 216 will be identified so that the user can enter the characters in the fields in one fluid motion, without having to separately select a point in each sub-field.

7) In top and bottom heuristics, if the sides of the field are bounded by text boxes or lines with limited extent (as in FIGS. 5, 7 and 11), the top and bottom of the field may be limited to the height of the bounding text, especially if no bounding edge (baseline or topline) was found.

8) In one embodiment, the field type (text entry, character box, checkbox) can be determined from the size, shape, and boundary nature of the detected element, as determined by the identification unit. The characteristics of the presumed form field may include: nature of each boundary (i.e. text box boundary, line boundary, lip boundary, nothing (limit)); connectedness of the boundary; width, height, and aspect of the region; and the presence of text (see step 2 above). An example of a set of rules based on these attributes includes: a) If width<W and height<H and form field is fully bounded, then the form field is a checkbox; b) If width<W and height<H and the form field is bounded only on sides, then the form field is a parentheses-style checkbox; c) If height>=MinTextHeight and aspect>MinTextAspect, then the form field is a text box; and d) If height>=MinTextHeight and width<MaxCharboxWidth and has a lip, then the form field is a character box.

9) In one embodiment, the semantic attributes of the field (date, name, etc. . . . ) may be determined by finding the closest text regions. “Closeness” in this context may include both Euclidean distance and graphical distance. For instance, if an interactively-determined form field region is in the same connected component as a text box, it would have distance=0. In addition, horizontal distance may be counted less strongly than vertical distance in assigning text to a field. Also, the predominant direction of the language in use can influence the “closeness.” In Western, left-to-right languages, text to the left of the detected field can be considered to have more influence over the semantic attributes of the detected form field region than text to the right of the detected field.

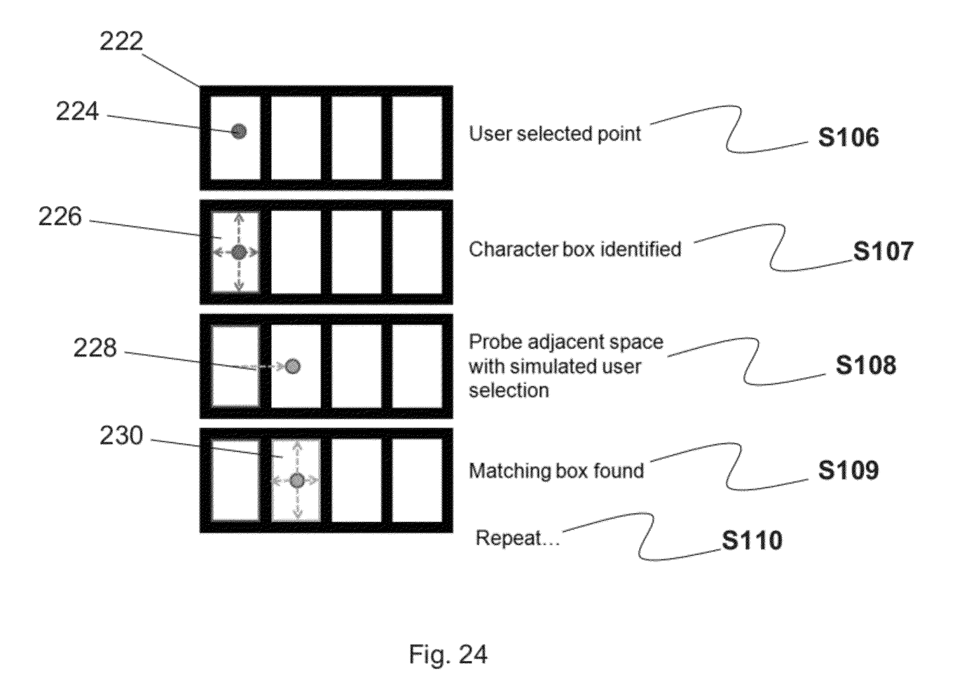

10) For repeated elements, like the character boxes 222 illustrated in FIG. 24, after the user selects a point 224 (step S106) and a character box 226 is identified (step S107), a graphical similarity search may be performed over the entire page, or alternatively a probe selection 228 can be made to the left and right of the detected character box (step S108), starting from where an adjacent box should be found. If a similar sized and adjacent box 230 is found from the probe selections (step S109), the adjacent box 230 is joined to the first box 226 to construct a single connected line of text boxes. The process continues (step S110) until no matching box region is found.

### III. Computer Embodiment

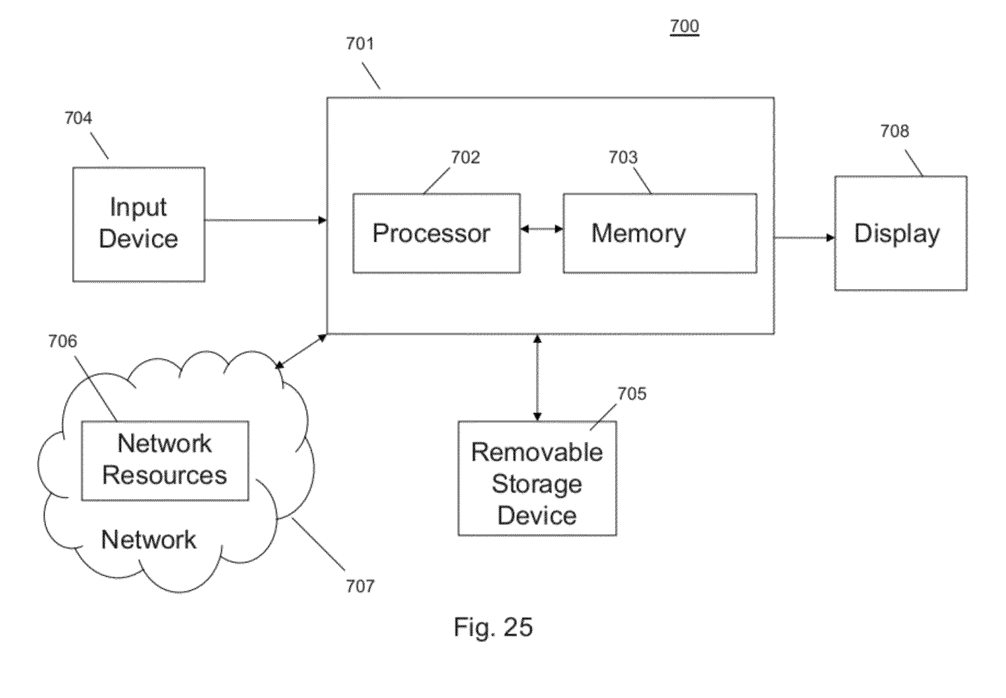

FIG. 25 is a block diagram that illustrates an embodiment of a computer/server system 700 upon which an embodiment of the inventive methodology may be implemented. The system 700 includes a computer/server platform 701 including a processor 702 and memory 703 which operate to execute instructions, as known to one of skill in the art. The term “computer-readable storage medium” as used herein refers to any tangible medium, such as a disk or semiconductor memory, that participates in providing instructions to processor 702 for execution. Additionally, the computer platform 701 receives input from a plurality of input devices 704, such as a keyboard, mouse, touch device or verbal command. The computer platform 701 may additionally be connected to a removable storage device 705, such as a portable hard drive, optical media (CD or DVD), disk media or any other tangible medium from which a computer can read executable code. The computer platform may further be connected to network resources 706 which connect to the Internet or other components of a local public or private network. The network resources 706 may provide instructions and data to the computer platform from a remote location on a network 707. The connections to the network resources 706 may be via wireless protocols, such as the 802.11 standards, Bluetooth® or cellular protocols, or via physical transmission media, such as cables or fiber optics. The network resources may include storage devices for storing data and executable instructions at a location separate from the computer platform 701. The computer interacts with a display 708 to output data and other information to a user, as well as to request additional instructions and input from the user. The display 708 may therefore further act as an input device 704 for interacting with a user.

The embodiments and implementations described above are presented in sufficient detail to enable those skilled in the art to practice the invention, and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

1. A system for detecting and creating fillable form fields in a digital document, comprising:
an input unit which receives an input from a user on a location of at least one form field in a digital document;
a processor that processes the received input;
an identification unit which identifies properties of the at least one form field;
a classification unit which classifies the at least one form field in the digital document by identifying a restricted type of input for the at least one form field, the classification unit classifying the at least one form field as receiving a textual input or a non-textual input; and
a generation unit which generates a fillable form field that receives the textual input or the non-textual input according to the classified at least one form field at the location of the at least one form field, the fillable form field restricting input based on the restricted type of input.

2. The system of claim 1, wherein the properties of the at least one form field include the location, a size and a shape.

3. The system of claim 1, wherein the properties of the at least one form field are determined using a boundary search initiated from the location input by the user.

4. The system of claim 1, wherein the at least one form field may be classified as a text box, a multi-character text box, a check box or a radio button.

5. The system of claim 4, wherein the classification unit classifies the at least one form field based on text adjacent to the at least one form field.

6. The system of claim 1, wherein the classification unit further classifies the text box based on the content of text to be entered into the fillable form field.

7. The system of claim 6, wherein the generation unit provides options for data to be entered into a text box based on the content of the text to be entered.

8. The system of claim 1, wherein the generation unit generates additional fillable form fields in additional locations in the digital document based on the identification and determination of a previous form field.

9. The system of claim 1, wherein the digital document is an image file.

10. The system of claim 9, wherein the fillable form field is created using HTML.

11. The system of claim 1, wherein the system is a web-based application accessible using an Internet browser.

12. The system of claim 11, wherein the user selects the digital document for detecting and completing of the form fields by inputting a uniform resource locator (URL) address corresponding to the location of the digital document.

13. The system of claim 1, wherein the identification unit identifies a first form field on a first page of a multi-page digital document and subsequently identifies identical form fields on additional pages of a multi-page digital document, and wherein the generation unit populates the identical form fields with the data entered by the user in the first form field on the first page.

14. The system of claim 13, wherein the identical form fields are highlighted.

15. The system of claim 1, wherein the information on the fillable form fields generated for a particular digital document are stored for future use with similar digital documents.

16. A method for detecting and creating fillable form fields in a digital document, comprising:
receiving an input from a user on a location of at least one form field in a digital document;
identifying properties of the at least one form field, the identifying comprising identifying a restricted type of input for the at least one form field;
classifying the at least one form field in the digital document as receiving a textual input or a non-textual input; and
generating a fillable form field that receives the textual input or the non-textual input according to the classified at least one form field at the location of the at least one form field, the fillable form field restricting input based on the identified restricted type of input.

17. The method of claim 16, further comprising inputting data into the at least one fillable form field.

18. The method of claim 16, wherein the properties of the at least one form field include the location, a size and a shape.

19. The method of claim 16, wherein the at least one form field is classified as a text box, a multi-character text box, a check box or a radio button.

20. The method of claim 19, wherein the at least one form field is classified based on text adjacent to the at least one form field.

21. A computer program product for detecting and creating fillable form fields in a digital document, the computer program product embodied on a computer readable storage medium and when executed by a computer, performs the method comprising:
receiving an input from a user on a location of at least one form field in a digital document;
identifying the location of the at least one form field;
determining the characteristics of the at least one form field in the digital document, the determining comprising determining a restricted type of input for the at least one form field and classifying the at least one form field as receiving a textual input or a non-textual input; and
generating a fillable form field that receives the textual input or the non-textual input according to the classified at least one form field at the location of the at least one form field, the fillable form field restricting input based on the restricted type of input.
